(19) United States
(12) Patent Application Publication
(10) Pub. No.: US 2021/0088339 A1
(43) Pub. Date: Mar. 25, 2021

(54) METHODS AND SYSTEMS FOR IDENTIFYING RAMP LINKS OF A ROAD

(71) Applicant: HERE GLOBAL B.V., Eindhoven (NL)

(72) Inventors: Zhenhua ZHANG, Chicago, IL (US); Leon STENNETH, Chicago, IL (US); Ram MARAPPAN, Naperville, IL (US)

(21) Appl. No.: 16/576,440

(22) Filed: Sep. 19, 2019

(51) Int. Cl. G01C 21/32

(52) U.S. Cl. CPC G01C 21/32

(57) ABSTRACT

A system, method and computer program product are provided for generating ramp link data of a road in a region. In an example embodiment, the method may include obtaining map data of the region, wherein the map data comprises link data of a plurality of links in the region. The method may further include determining at least one link pair corresponding to the road from the map data of the region based on one or more of a link start criterion, a heading criterion, or an uplink criterion. The method may further include determining one or more attributes of each link of the obtained at least one link pair and generating the ramp link data of the road based on the one or more attributes of each link of the at least one link pair.

### TECHNOLOGICAL FIELD

The present disclosure generally relates to routing and navigation, and more particularly relates to identification of ramp links of a road, such as a highway.

### BACKGROUND

Various navigation applications are available to provide assistance, for example directions for driving, walking, or other modes of travel. Web-based and mobile app-based systems offer navigation applications that allow a user to request directions from one point to another. Quite often, a vehicle receiving the navigation assistance has to traverse a highway as a part of the route between a source and a destination location. In order to enter and exit such highways, the vehicle should be accurately informed about the exact starts and ends of ramp links to such highways. More importantly, in the context of autonomous vehicles, it is of utmost importance that the navigation assistance provide correct identification of ramp links on the highways. To this end, the map data utilized for providing the navigation assistance should provide accurate identification of such ramp links. Current solutions may not provide accurate identification of ramp links of highways as part of the map data. As such, incorrect triggering of ramp location may lead to issues of speed problems around the ramps and issues of lane change, which may even lead to accidents for the vehicles. Especially, in the context of navigation assistance for autonomous vehicles, it is important that the assistance provided is real-time and accurate.

### BRIEF SUMMARY

Accordingly, there is a need for providing reliable, accurate, and near real time identification of ramp links associated with a route. Example embodiments of the present disclosure provide a system, a method, and a computer program product for identifying ramp links associated with a road.

Some example embodiments disclosed herein provide a system for identifying one or more ramp links associated with a road in a region. The system comprises a memory configured to store computer-executable instructions and one or more processors configured to execute the instructions to obtain map data of the region. The map data comprises link data of a plurality of links in the region. The one or more processors are further configured to determine at least one link pair corresponding to the road from among the plurality of links, based on the map data of the region. The at least one link pair satisfies one or more of a link start criterion, a heading criterion, or an uplink criterion. The one or more processors are further configured to determine one or more attributes of each link of the obtained at least one link pair. The one or more processors are further configured to generate the ramp link data of the road based on the one or more attributes of each link of the at least one link pair.

According to some example embodiments, the one or more processors are further configured to update the map data of the region based on the generated ramp link data of the road.

According to some example embodiments, the link data comprises a link start and a link end of each of the plurality of links. To obtain the at least one link pair, the one or more processors are further configured to extract a plurality of subject link pairs from the plurality of links based on the link start criterion. The link start criterion comprises a first condition that a link start of each link of a respective one of the plurality of subject link pairs is same.

According to some example embodiments, the link data further comprises upstream heading data and downstream heading data of each of the plurality of links. To obtain the at least one link pair the one or more processors are further configured to extract the plurality of subject link pairs from the plurality of links based on the heading criterion. The heading criterion comprises a second condition that an absolute difference between upstream heading of each link of a respective one of the plurality of subject link pairs is less than or equal to a threshold value.

According to some example embodiments, the link data further comprises road classifier data, map speed limit, and lane count of each of the plurality of links. To obtain the at least one link pair, the one or more processors are further configured to filter the plurality of subject link pairs based on the uplink criterion.

According to some example embodiments, to filter the extracted plurality of subject link pairs, the one or more processors are further configured to determine an uplink from among the plurality of links for each of the plurality of subject link pairs. The link end of the uplink is same as a link start of each link of the respective one of the plurality of subject link pairs. The uplink criterion comprises one or more of a third condition that an absolute difference between a downstream heading of a respective uplink and an upstream heading of each link of the respective one of the plurality of subject link pairs is less than or equal to the threshold value, a fourth condition that a road classifier of the uplink corresponds to a high speed road, or a fifth condition that a map speed limit of the uplink is greater than or equal to a threshold speed limit value.

According to some example embodiments, the at least one link pair comprises a first link and a second link. The one or more attributes of each link of the obtained at least one link pair comprise one or more of map speed limit, lane count or upstream heading of each of the first link and the second link. To generate the ramp link data of the road, the one or more processors are further configured to determine at least one ramp link for the road from among the first link and the second link to generate the ramp link data of the road based on a ramp link extraction criteria.

According to some example embodiments, the ramp link extraction criteria comprises one or more of a first condition that a link with least lane count among the first link and second link is the ramp link. The second condition that a link with least map speed limit among the first link and second link is the ramp link or a third condition that a link with highest absolute heading difference with respective main link, among the first link and second link is the ramp link.

In some example embodiments, a method may be provided for identifying one or more ramp links associated with a road in a region. The method comprises obtaining map data of the region. The map data comprises link data of a plurality of links in the region. The method may include determining at least one link pair corresponding to the road from the map data of the region based on one or more of a link start criterion, a heading criterion or an uplink criterion. The method may further include determining one or more attributes of each link of the obtained at least one link pair. The method may further include generating ramp link data of the road, based on the one or more attributes of each link of the at least one link pair.

Some example embodiments disclosed herein may provide a computer programmable product comprising a non-transitory computer readable medium having stored thereon computer executable instruction which when executed by one or more processors, cause the one or more processors to carry out operations for identifying one or more ramp links associated with a road in a region, the operations comprising obtaining map data of the region, the map data comprising link data of a plurality of links in the region. The operations further comprise determining at least one link pair corresponding to the road from the map data of the region based on one or more of a link start criterion, a heading criterion, or an uplink criterion. The operations further comprise determining one or more attributes of each link of the obtained at least one link pair. The operations further comprise generating ramp link data of the road, based on the one or more attributes of each link of the at least one link pair.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a schematic diagram of a network environment of a system for identifying one or more ramp links associated with a road in a region, in accordance with an example embodiment;

FIG. 2 illustrates a block diagram of the system, exemplarily illustrated in FIG. 1, for identifying one or more ramp links associated with a road in a region, in accordance with an example embodiment;

FIG. 3A illustrates an exemplary scenario of a working example of the system, exemplarily illustrated in FIG. 1, for identifying one or more ramp links associated with a road in a region, in accordance with an example embodiment;

FIG. 3B illustrates a schematic diagram showing link attributes of a map link, for identifying one or more ramp links associated with a road in a region, in accordance with an example embodiment;

FIG. 4 illustrates a flow diagram of a method for extracting a ramp link from a plurality of links, in accordance with an example embodiment; and

FIG. 5 illustrates a flow diagram of a method for identifying ramp links associated with a road in a region, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “road” may refer to a way leading a traveler from one location to another. The road may have a single lane or multiple lanes.

The term “lane” may refer to a part of a road that is designated for travel of vehicles or pedestrians as per some condition.

The term “link” may refer to any connecting pathway including but not limited to a roadway, a highway, a freeway, an expressway, a lane, a street path, a road, an alley, a controlled access roadway, a free access roadway and the like.

The term “upstream heading” may refer to the heading of the start location of the link, measured as the heading of the vector formed by the link start and its nearest shape location.

The term “downstream heading” may refer to the heading of the end location of the link, measured as the heading of the vector formed by the link end and its nearest shape location.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car or autonomous car. For example, the vehicle may have zero passengers or passengers that do not manually drive the vehicle, but the vehicle drives and maneuvers automatically. There can also be semi-autonomous vehicles.

### End of Definitions

Embodiments of the present disclosure may provide a system, a method and a computer program product for identifying one or more ramp links associated with a road in a region. To this end, the ramp link data of the one or more ramp links may be generated. In one or more example embodiments, the generated ramp link data may be used for updating map data of the region that may be used for navigating a vehicle. The system, method, and computer program product disclosed herein may provide accurate location of the ramp links, for autonomous, semi-autonomous vehicles and manually driven vehicles to avoid incorrect triggering of exit ramps and speed limits around ramps. These and other technical improvements of the invention will become evident from the description provided herein.

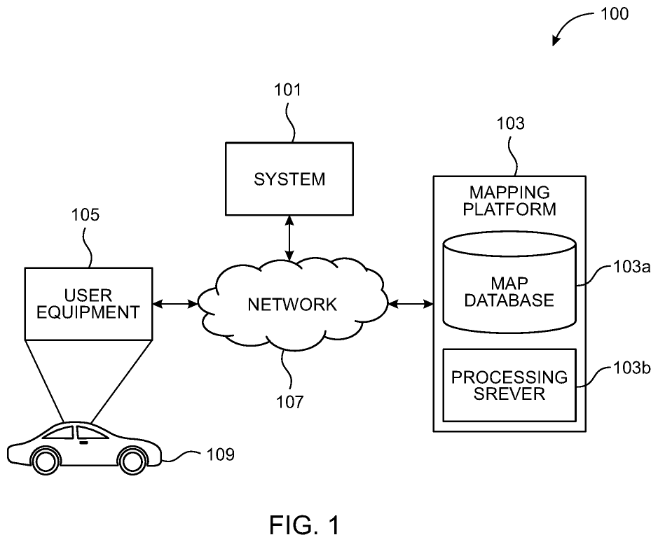

FIG. 1 illustrates a schematic diagram of a network environment 100 of a system 101 for identifying one or more ramp links associated with a road in a region, in accordance with an example embodiment. The system 101 may be communicatively coupled to a mapping platform 103 and a user equipment (UE) 105 via a network 107. As per specific requirements, the system 101 may also be communicatively coupled to other components not shown on FIG. 1 via a network 107.

The system 101 may be embodied in one or more of several ways as per the required implementation. For example, the system 101 may be embodied as a cloud based service or a cloud based platform. As such, the system 101 may be configured to operate outside the user equipment 105. However, in some example embodiments, the system 101 may be embodied within the user equipment 105, for example as part of an in-vehicle navigation system. In each of such embodiments, the system 101 may be communicatively coupled to the components shown in FIG. 1 to carry out the desired operations and wherever required modifications may be possible within the scope of the present disclosure.

The mapping platform 103 may comprise a map database 103a for storing map data and a processing server 103b. The map database 103a may store node data, road segment data, link data, point of interest (POI) data, link identification information, heading value records or the like. The map database 103a may also store cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 103a may contain path segment and node data records, such as shape points or other data that may represent pedestrian paths, links or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a can include event data (e.g., traffic incidents, construction activities, scheduled events, unscheduled events, accidents, diversions etc.) associated with the POI data records or other records of the map database 103a.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by user equipment 105. The navigation-related functions may correspond to vehicle navigation, pedestrian navigation or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment 105 to provide navigation and/or map-related functions. For example, the map database 103a may be used with the user equipment 105 to provide an end user with navigation features. In such a case, the map database 103a may be downloaded or stored on the user equipment 105.

The processing server 103b may comprise processing means and communication means. For example, the processing means may comprise one or more processors configured to process requests received from the user equipment 105. The processing means may fetch map data from the map database 103a and transmit the same to the user equipment 105 in a format suitable for use by the user equipment 105. In one or more example embodiments, the mapping platform 103 may periodically communicate with the user equipment 105 via the processing means 103b to update a local cache of the map data stored on the user equipment 105. Accordingly, in some example embodiments, the map data may also be stored on the user equipment 105 and may be updated based on periodic communication with the mapping platform 103.

The user equipment 105 may be any user accessible device such as a mobile phone, a smartphone, a portable computer, and the like that is portable in itself or as a part of another portable/mobile object such as a vehicle 109. In some example embodiments, user equipment 105 may be the vehicle 109 itself. The user equipment 105 may comprise a processor, a memory and a communication interface. The processor, the memory and the communication interface may be communicatively coupled to each other. In some example embodiments, the user equipment 105 may be associated, coupled, or otherwise integrated with a vehicle (such as the vehicle 109), such as an advanced driver assistance system (ADAS), a personal navigation device (PND), a portable navigation device, an infotainment system and/or other device that may be configured to provide route guidance and navigation related functions. The vehicle 109 may be an autonomous semi-autonomous vehicle or a manually driven vehicle. In such example embodiments, the user equipment 105 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 105. Additional, different, or fewer components may be provided. For example, the user equipment 105 may be configured to execute and run mobile applications such as a messaging application, a browser application, a navigation application, and the like. At least in some example embodiments, the user equipment 105 may be directly coupled to the system 101 via the network 107. As such, the user equipment 105 may be a dedicated vehicle (or a part thereof) for gathering data for development of the map data in the database 103a. In some alternate embodiments, the user equipment 105 may be accessible via an OEM cloud. That is, instead of being directly connected to the network 107, the user equipment 105 may be connected to the OEM cloud which in turn may be connected to the network 107. In such example embodiments, the user equipment 105 may be a consumer vehicle (or a part thereof) and may be a beneficiary of the services provided by the system 101 and/or the mapping platform 103. Although a single user equipment 105 is shown in the example environment 100 of FIG. 1, it may however be contemplated that more than one user equipment may also be possible within the scope of this disclosure and therefore, the system 101 may be communicatively coupled to as many user equipment as may be required for a specific implementation. In some example embodiments, the user equipment 105 may serve the dual purpose of a data gatherer and a beneficiary device. The user equipment 105 may be configured to capture sensor data associated with a road which the user equipment 105 may be traversing. The sensor data may for example be image data of road objects, road signs, or the surroundings (for example buildings, road objects, and the like).

In some example embodiments, the user equipment 105 may comprise acoustic sensors such as a microphone array, position sensors such as a GPS sensor, orientation sensors such as gyroscope, motion sensors such as accelerometer, a display enabled user interface such as a touch screen display, and other components as may be required for specific functionalities of the user equipment 105.In some embodiments, the system 101 may be implemented in the user equipment 105. Therefore, a local copy of map data is stored in the cache memory of user equipment 105.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof

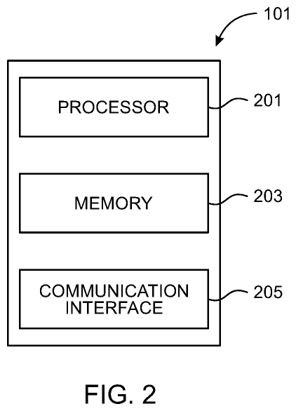

FIG. 2 illustrates a block diagram of the system101 for identifying one or more ramp links associated with a road in a region, in accordance with an example embodiment. The system 101 may include a processing means such as at least one processor 201 (hereinafter, also referred to as “processor 201”), storage means such as at least one memory 203 (hereinafter, also referred to as “memory 203”), and a communication means such as at least one communication interface 205 (hereinafter, also referred to as “communication interface 205”). The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101, where the users may be a traveler, a rider, a pedestrian, and the like. In some embodiments, the users may be or correspond to an autonomous or semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101.

Additionally or alternatively, the processor 201 may include one or more processors capable of processing large volumes of workloads and operations to provide support for big data analysis. In an example embodiment, the processor 201 may be in communication with a memory 203 via a bus for passing information among components that may be coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communication to and from the user equipment 105. The communication interface 205 may be any means such as a device or circuitry embodied in either hardware or a combination of hardware and software that is configured to receive and/or transmit data to or from a communication device in communication with the user equipment 105. In some environments, the communication interface 205 may alternatively or additionally support wired communication. As such, for example the communication interface 205 may include a communication modem and/or other hardware and/or software for supporting communication via cable, digital subscriber line(DSL), universal serial bus(USB) or other mechanisms.

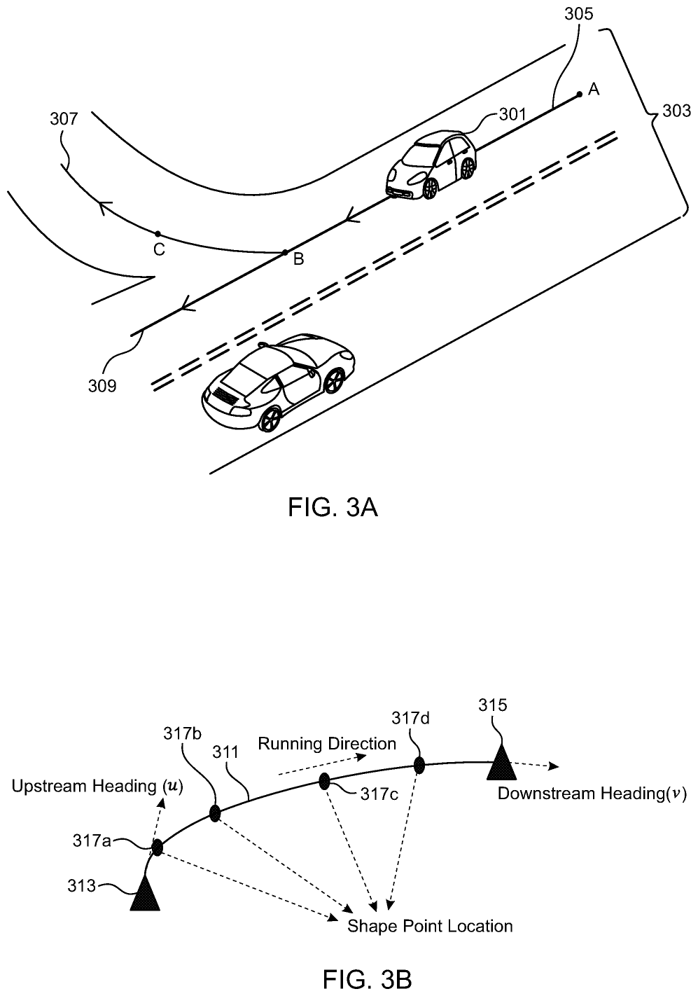

FIG. 3A illustrates an exemplary scenario of a working example of the system 101 for identifying one or more ramp links associated with a road, in accordance with an example embodiment. According to one example embodiment, a vehicle 301 (such as the vehicle 109) may be traveling on a road 303. The road 303 may be part of a way leading the vehicle 301 from a source location to a destination location. In one example, the road 303 may be a one-way or a two-way road. In the example embodiment illustrated in FIG. 3A, the road 303 is a one-way road. Additionally, the road 303 may comprise a single lane or multiple lanes, that is, the road may be a single lane road, a two lane road or a four lane road.

The vehicle 301 may request for a route between two locations and the road 303 may be a part of the requested route. Further, the navigation instructions for the route may comprise taking an exit from the road 303 to enter a ramp link. The system 101 may be invoked upon receipt of the request for route to identify such a ramp link for the road 303. Alternately, the ramp link may already be indicated in the route for the vehicle 301 and the system 101 may be invoked to generate map data of the ramp links so as to check whether the ramp link is correctly marked or not. Irrespective of the manner in which the system 101 is triggered, the system 101 may provide measures for generating ramp link data for the road 303.

On being triggered, the system 101 may obtain the map data of the region encompassed by the route from a data source such as the map database 103a. The map data may comprise for example, map data of the links that the route may encompass in the region. The map data of a link may comprise one or more of a link start node, a link end node, upstream heading, downstream heading, uplink data, shape location points, road classifier data, lane count or map speed limit associated with the particular link. In an example embodiment, the road 303 may comprise a link 305 that is being traversed or is to be traversed by the vehicle 301 (i.e. the link 305 may be the current map link of the vehicle 109). The current map link 305 may have a link start node “A” and a link end node “B”. The link start node A may refer to the point from where the current map link 305 starts and the link end node B may refer to the point where the current map link B terminates. In an embodiment, point ‘C’ may correspond to the shape point location of a candidate ramp link 307. Point C may indicate the point where the ramp link changes the shape (i.e. heading of the candidate ramp link 307 changes). In an example embodiment, shape point locations may be used for determining the heading of a link, a detailed description of which is provided next with reference to FIG. 3B.

FIG. 3B illustrates a schematic diagram showing shape point locations of a link 311, in accordance with an example embodiment. FIG. 3B is described in conjunction with FIG. 3A. One or more link attributes of the link 311 may be used for determining heading of the link 311 (such as any of the current map link 305, candidate ramp link 307 or the main link 309), in accordance with an example embodiment. The link 311 may start from a start node 313 and terminate at an end node 315. Further, the link 311 may have corresponding shape point locations 317a, 317b, 317c, and 317d. The upstream heading (u) of the link 311 may be defined as the heading of the start node 313 of the link 311, measured as the heading of the vector formed by the start node 313 and the nearest shape location point i.e. 317a. Similarly, the downstream heading (v) may be defined as the heading of the end node 315 of the link 311, measured as the heading of the vector formed by the nearest shape location of the end node 315 (i.e. in this case 317d) and the end node 315.

Referring back to FIG. 3A, the route generated by the system 101, in response to the request made, may comprise a sequence of links. The system 101 may fetch all links having a common start node and extracts all pairs of links having a common start node and an absolute upstream heading difference value being around 30 degrees or 330 degrees. An offset of +10 degrees may be permissible to filter such pair of links. It may be understood that although the threshold value for the absolute heading difference is chosen as 30 degrees or 330 degrees, any suitable value that may be useful for extracting ramp links may be selected for the threshold value. The absolute upstream heading difference between two links may be defined as the angle between the upstream vector of each of the links. In the exemplary scenario depicted in FIG. 3A, the potential ramp link 307 and the main link 309 may be extracted as a valid pair of links since both of them have a common link start node “B” and the absolute heading difference (i.e. angle CBD) around 30 degrees.

After extracting all pair of links satisfying the common link start node criterion and the absolute heading difference criterion, the system 101 may filter the link pairs based on an uplink criteria. The extracted pair of links may include false positives i.e. links which may have a common start node and an absolute heading difference equal to a threshold value. However, such false positives may not correspond to links having a ramp link. Example scenarios of such false positive cases may emerge across intersections and crossroads. The system 101 may determine the uplinks of each pair of uplink filtered links and filter out those link pairs that have multiple uplinks. In other words, those link pairs which have only one qualified uplink to avoid conditions like false positive near intersections. For example, at an intersection of two roads, there may be a link pair emerging from the junction of the intersection. That is, the pair of links emerging from the intersection may have two uplinks (the two links converging into the junction of the intersection). The pair of links emerging from the junction still satisfy the common link start node criterion and are therefore false positive cases. Ramp links do not have multiple uplinks and therefore, it is important to filter such false positive links from the extracted link pairs. Towards this end, the system 101 may determine the uplinks of each extracted pair of links and filter them based on the uplink criteria.

The uplink may be defined as the link from which the link pair emanates (i.e. the preceding link of the link pair). The uplink criteria may comprise one or more of a first condition that a link end of an uplink is the same as link start of the link pair (both links in the link pair have common link start node), a second condition that a difference between the uplink's downstream heading and link pair's upstream heading (i.e. upstream heading of each link of the link pair) being around 30 degrees or 330 degrees, a third condition that road classifier of the uplink corresponds to a high speed road, or a fourth condition that map speed limit of the uplink is greater than or equal to a threshold speed limit value. The system 101 may utilize any or all of the uplink criterions for filtering the extracted link pairs.

The first condition filters out link pairs that do not emerge from a common uplink. This is necessary because ramp links always diverge from a road. In other words, the ramp link should have a preceding link from which it emanates/diverges. Therefore the first condition ensures that only those links that have a common uplink qualify for further processing. The second condition filters out link pairs that correspond to non-ramp links of a roadway. For example, a roadway may bifurcate or merge into another roadway. However, such links do not correspond to ramp links. A ramp link usually has a gentle curvature with respect to its uplink and therefore the difference between the uplink's downstream heading and the potential ramp link's upstream heading should be small (such as 30 degrees or 330 degrees; however any suitable threshold angle value may be defined). Therefore, the second link filters out such links that may have a common uplink but may not be a potential ramp link.

The third condition filters out such links that do not correspond to a specific type of road (such as highways). Roadways in a geographic area may be categorized as per several factors such as their expected traffic speed, geometry, lane count, or accessibility reach. For example, in most of the countries roads may be classified into various function classes, each designating a specific type of road. In an embodiment, the road classifiers may be defined as functional class in few areas and may be designated by a value ranging from 1 to 5, where number 1 is assigned to a freeway, highway or an expressway and number 5 to other type of roads such as rural roads. Similarly, in few counties link China the roads may be assigned classifiers such as Gxxx, Sxxx, Xxxx, Yxxx, and Cxxx; where Gxxx (or guódào) is assigned to national highways, Sxxx (or shěngdào) is assigned to provincial roads, Xxxx (or xiàndào) is assigned to county level roads, Yxxx (or xiāngdào) is assigned to township level roads, and Cxxx (or cūndào) is assigned to village level roads. Therefore, link pairs whose uplink does not correspond to a particular type of road (i.e. they are not of interest) may be filtered out from further processing. The fourth condition filters out link pairs whose uplink does not have a map speed limit equal to that of a candidate road type (for example a highway). The threshold value for the map speed limit may be a configurable value and may be defined as per the requirement.

The system 101 may obtain various data (such as uplink data of link pairs, uplink's downstream heading data, the potential ramp link's upstream heading data, road classifier data of uplink, and map speed data of uplink) required for executing the uplink filtering criteria from suitable data sources such as the map database 103a. The system 101 may filter out all possible false positive links that do not correspond to ramp links and thus obtain, uplink filtered link pairs.

In the exemplary scenario depicted in FIG. 3A, the candidate ramp link 307 and the main link 309 satisfy the first condition of the uplink filtering criteria since the link start node ‘B’ of the link pair 307, 309 is same as the link end ‘B’ of their uplink 305. Also, in some example embodiments, the difference between the downstream heading of the uplink 305 and the upstream heading of the link pair 305, 307 may be around 30 degrees. For example, the upstream heading of the main link 309 is 0 degrees and upstream heading of the candidate ramp link 307 is around 30 degrees. Therefore, the difference between the downstream heading of the uplink 305 and the upstream heading of the link pair 307, 309 is around 30 degrees. As such, the link pair 307, 309 may satisfy the second condition of the uplink filtering criteria. Further, in some example embodiments, the road classifier of the uplink 305 may correspond to a high speed road having a map speed equal to or higher than a threshold value for highways. As such, the link pair 307, 309 may satisfy the third condition and the fourth condition of the uplink filtering criteria. Therefore, the link pair of the candidate ramp link 307 and the main link 308 may be obtained as an uplink filtered link pair.

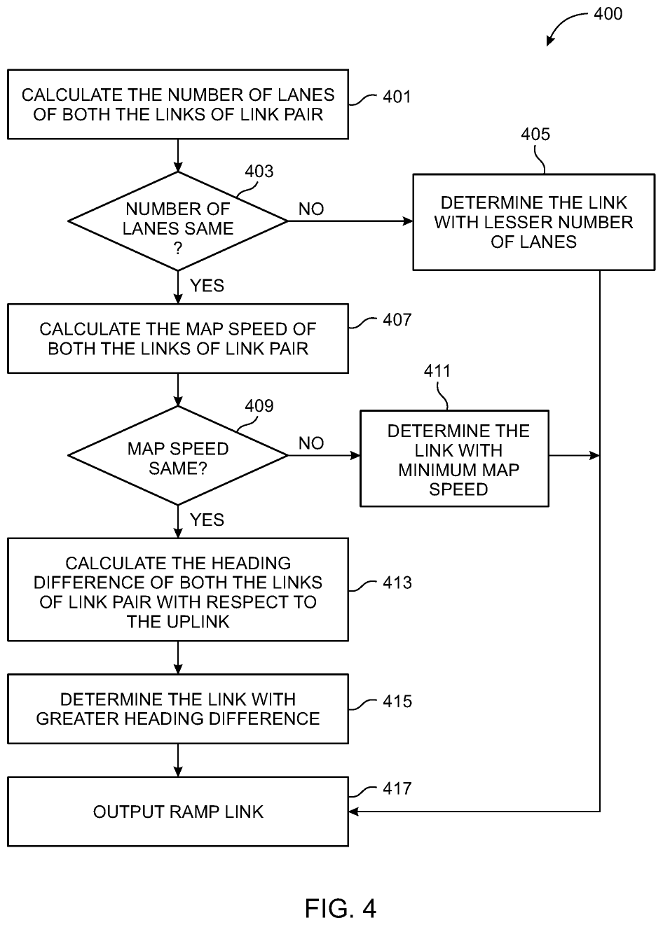

The obtained uplink filtered link pairs correspond to true cases for determining ramp links. Accordingly, the system 101 may next determine which link among such pairs of uplink filtered links corresponds to the ramp link. The extraction of ramp link from each uplink filtered link pair may be executed based on a ramp link extraction criteria, a detailed description of which is provided next with reference to FIG. 4.

FIG. 4 illustrates a flow diagram of a method 400 for extracting a ramp link from an uplink filtered link pair, in accordance with an example embodiment. The system 101 executes the ramp link extraction based on a ramp link extraction criterion. The system 101 may determine an absolute heading difference between each link of the uplink filtered link pair and its uplink. For each link of the uplink filtered link pair, the system 101 may also obtain lane category data and map speed data from a suitable data source such as the map database 103a. The lane category data may represent a lane count of a road associated with a link and the map speed data may represent the designated drive speed of vehicles for the road associated with the link. The ramp link extraction criteria may comprise a three step logic to obtain the ramp link among the uplink filtered link pair. A candidate uplink filtered link pair may be considered to have two links—a first link and a second link. In the example embodiment illustrated in FIG. 3A, the link pair of links 307, 309 qualifies as an uplink filtered link pair.

At step 401, the system 101 may obtain the lane count (i.e. number of lanes in the road associated with a link) from the lane category data for both of the first link and the second link, of the uplink filtered link pair. At step 403, the system 101 may determine whether the number of lanes is same for both of the first link and the second link of the uplink filtered link pair. If the number of lanes is different for both the first link and the second link of the uplink filtered link pair, the control may pass to step 405 where the system 101 may determine the link with lesser number of lanes among the first link and the second link and the control may pass to step 417. At 417, the system 101 may output the link that has the lesser number of lanes outputted as the ramp link and the method 400 may terminate.

Alternately, if at step 403 the number of lanes for both of the first link and the second link is same, the control may pass onto step 407. At step 407, the system 101 may calculate the map speed of both of the first link and the second link of the uplink filtered link pair. At step 409, the system 101 may determine whether the map speed is same for both of the first link and the second link of the uplink filtered link pair. At 409, if the map speed for both of the first link and the second link of the uplink filtered link pair is different, the control may pass to step 411 where the system 101 may determine the link with minimum map speed among the first link and the second link and the control may pass to step 417. At 417, the system 101 may output the link with minimum map speed among the first link and the second link as the ramp link and the method 400 may terminate. However, if at 409, the map speed for both of the first link and the second link of the uplink filtered link pair is same, the control may pass to 413.

At step 413, when the map speed is same for both links of the uplink filtered link pair, the system 101 may calculate the absolute heading difference with respect to the uplink for each of the first link and the second link of the uplink filtered link pair. At step 415, the system 101 may determine the link with a greater absolute heading difference among the first link and the second link and the control may pass to 417. At 417, the system 101 may output the link with greater absolute heading difference among the first link and the second link as the ramp link and the method 400 may terminate.

The link outputted at 417 may be designated as the ramp link and map data of the ramp link may be outputted by the system 101. In this way, all the ramp links existing within a map region may be extracted and map data of the region may be updated to correctly reflect the accurate location, map speed and the like of the extracted ramp links.

In the exemplary scenario depicted in FIG. 3A, the system 101 may identify the candidate ramp link 307 as the ramp link for the road 303. Accordingly, the mapping platform 103 may inform the vehicle 301 in advance of the correct location, speed limit and the like of the ramp link to ensure reliable navigation assistance. The vehicle 301 may accordingly modify the drive speed or change the lane precisely and in advance. The indication provided to the vehicle 301 may aid in avoiding sudden turns or breaks around the ramps.

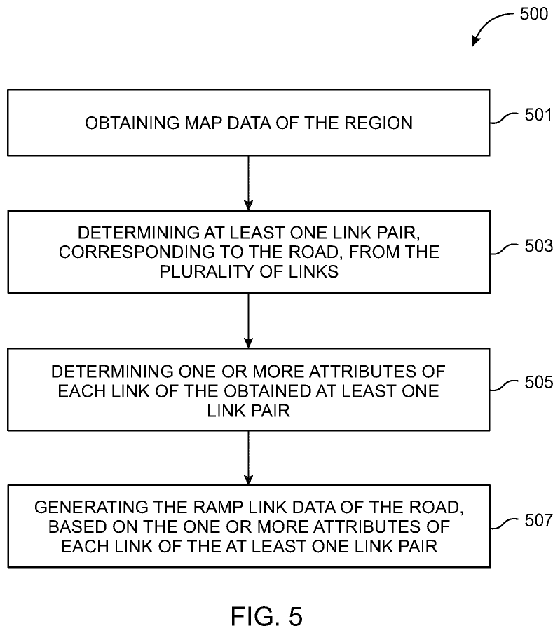

FIG. 5 illustrates a flow diagram of a method 500 for identifying ramp links associated with a road in a region, in accordance with an example embodiment. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

At step 501, the method comprises obtaining map data of the region. The map data may comprise link data of a plurality of links in the region. When a request for route is made by a user, the plurality of links encompassed by the route may be obtained from the map database 103a. Each of the plurality of links includes a link start and a link end.

At 503, the method comprises determining at least one link pair corresponding to road from the plurality of links based on the map data of the region. The at least one link pair obtained from the link data satisfies one or more of a link start criterion, a heading criterion or an uplink criterion. The link start criterion may comprise a condition that a link start of each link of a respective one of the plurality of subject link pairs is same. The heading criterion may comprise a condition that an absolute difference between upstream heading of each link of a respective one of the plurality of subject link pairs is less than or equal to a threshold value. The uplink criteria may be same as the uplink filtering criteria described with reference to FIG. 3A.

Further, at step 505, the method 500 may include, determining one or more attributes of each link of the obtained at least one link pair. The at least one link pair may comprise a first link and a second link. In an example embodiment, the one or more attributes may include number of lanes, map speed and an absolute heading difference with respect to the uplink of each of the first link and second link. At 507, the method comprises generating the ramp link data of the road, based on the one or more attributes of each link of the at least one link pair.

The method 500 may be implemented using corresponding circuitry. For example, the method 500 may be implemented by an apparatus or system comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 500.

In an example embodiment, an apparatus for performing the method 500 of FIG. 5 above may comprise a processor (e.g. the processor 201) configured to perform some or each of the operations of the method of FIG. 5 described previously. The processor may, for example, be configured to perform the operations (501-507) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (501-507) may comprise, for example, the processor 201 which may be implemented in the system 100 and/or a device or circuit for executing instructions or executing an algorithm for processing information as described above.

In this way, example embodiments of the invention result in generation of map data of a ramp link by extracting the ramp link from plurality of links of a road. In many situations, some highway exits may not be labelled as ramps in map database. Instead they may be labelled as POI exit roads, frontage road or maneuver road. In such situations it becomes difficult for vehicles to accurately follow navigation instructions around ramps which may lead to situations of accidents. Thus, the unique methodology described herein, pertaining to accurate identification of location of ramps helps in mitigating the above problems. The accurate location may be indicated to the vehicle to limit the speed and reducing challenges related to speed limit around ramps and lane change.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for identifying one or more ramp links associated with a road in a region, the system comprising:
a memory configured to store computer executable instructions; and
one or more processors configured to execute the instructions to:
obtain map data of the region, wherein the map data comprises link data of a plurality of links in the region;
determine at least one link pair, corresponding to the road, from among the plurality of links, based on the map data of the region, wherein the at least one link pair satisfies one or more of a link start criterion, a heading criterion, or an uplink criterion;
determine one or more attributes of each link of the obtained at least one link pair; and
generate ramp link data of the one or more ramp links associated with the road, based on the one or more attributes of each link of the at least one link pair.

2. The system of claim 1, wherein the one or more processors are further configured to update the map data of the region, based on the generated ramp link data of the road.

3. The system of claim 1,
wherein the link data comprises a link start and a link end of each of the plurality of links,
wherein to obtain the at least one link pair, the one or more processors are further configured to extract a plurality of subject link pairs from the plurality of links, based on the link start criterion, and
wherein the link start criterion comprises a first condition that a link start of each link of a respective one of the plurality of subject link pairs is same.

4. The system of claim 3,
wherein the link data further comprises upstream heading data and downstream heading data of each of the plurality of links,
wherein to obtain the at least one link pair, the one or more processors are further configured to extract the plurality of subject link pairs from the plurality of links, based on the heading criterion, and
wherein the heading criterion comprises a second condition that an absolute difference between upstream heading of each link of a respective one of the plurality of subject link pairs is less than or equal to a threshold value.

5. The system of claim 4,
wherein the link data further comprises road classifier data, map speed limit, and lane count of each of the plurality of links, and
wherein to obtain the at least one link pair, the one or more processors are further configured to filter the plurality of subject link pairs, based on the uplink criterion.

6. The system of claim 5,
wherein to filter the extracted plurality of subject link pairs, the one or more processors are further configured to determine, for each of the plurality of subject link pairs, an uplink from among the plurality of links,
wherein a link end of the uplink is same as a link start of each link of the respective one of the plurality of subject link pairs, and
wherein the uplink criterion comprises one or more of:
a third condition that an absolute difference between a downstream heading of a respective uplink and an upstream heading of each link of the respective one of the plurality of subject link pairs is less than or equal to the threshold value,
a fourth condition that a road classifier of the uplink corresponds to a high speed road, or
a fifth condition that a map speed limit of the uplink is greater than or equal to a threshold speed limit value.

7. The system of claim 1,
wherein the at least one link pair comprises a first link and a second link,
wherein the one or more attributes of each link of the obtained at least one link pair comprise one or more of map speed limit, lane count, or upstream heading of each of the first link and the second link, and
wherein c, the one or more processors are further configured to determine at least one ramp link for the road from among the first link and the second link, based on a ramp link extraction criteria.

8. The system of claim 7, wherein the ramp link extraction criteria comprises one or more of:
a first condition that a link with least lane count among the first link and second link is the ramp link;
a second condition that a link with least map speed limit among the first link and second link is the ramp link; or
a third condition that a link with highest absolute heading difference with respective main link, among the first link and second link, is the ramp link.

9. A method for identifying one or more ramp links associated with a road in a region, the method comprising:
obtaining map data of the region, wherein the map data comprises link data of a plurality of links in the region;
determining at least one link pair, corresponding to the road, from among the plurality of links, based on one or more of a link start criterion, a heading criterion, or an uplink criterion;
determining one or more attributes of each link of the obtained at least one link pair; and
generating ramp link data of the road, based on the one or more attributes of each link of the at least one link pair.

10. The method of claim 9, further comprising updating the map data of the region based on the generated ramp link data of the road.

11. The method of claim 9,
wherein the link data comprises a link start and a link end of each of the plurality of links,
wherein obtaining the at least one link pair further comprises extracting a plurality of subject link pairs from the plurality of links, based on the link start criterion, and
wherein the link start criterion comprises a first condition that a link start of each link of a respective one of the plurality of subject link pairs is same.

12. The method of claim 11,
wherein the link data further comprises upstream heading data and downstream heading data of each of the plurality of links,
wherein obtaining the at least one link pair further comprises extracting the plurality of subject link pairs from the plurality of links, based on the heading criterion, and
wherein the heading criterion comprises a second condition that an absolute difference between upstream heading of each link of a respective one of the plurality of subject link pairs is less than or equal to a threshold value.

13. The method of claim 12,
wherein the link data further comprises road classifier data, map speed limit, and lane count of each of the plurality of links, and
wherein obtaining the at least one link pair further comprises filtering the plurality of subject link pairs, based on the uplink criterion.

14. The method of claim 13,
wherein filtering the extracted plurality of subject link pairs further comprises determining, for each of the plurality of subject link pairs, an uplink from among the plurality of links,
wherein a link end of the uplink is same as a link start of each link of the respective one of the plurality of subject link pairs, and
wherein the uplink criterion comprises:
a third condition that an absolute difference between a downstream heading of a respective uplink and an upstream heading of each link of the respective one of the plurality of subject link pairs is less than or equal to the threshold value,
a fourth condition that a road classifier of the uplink corresponds to a high speed road, or
a fifth condition that a map speed limit of the uplink is greater than or equal to a threshold speed limit value.

15. The method of claim 9,
wherein the at least one link pair comprises a first link and a second link,
wherein the one or more attributes of each link of the obtained at least one link pair comprise one or more of map speed limit, lane count, or upstream heading of each of the first link and the second link, and
wherein generating the ramp link data of the road further comprises determining at least one ramp link for the road from among the first link and the second link, based on a ramp link extraction criterion.

16. The method of claim 9, wherein the ramp link extraction criterion comprises one or more of:
a first condition that a link with least lane count among the first link and second link is the ramp link;
a second condition that a link with least map speed limit among the first link and second link is the ramp link; or
a third condition that a link with highest absolute heading difference with respective main link, among the first link and second link is the ramp link.

17. A computer programmable product comprising a non-transitory computer readable medium having stored thereon computer executable instruction which when executed by one or more processors, cause the one or more processors to carry out operations for identifying one or more ramp links associated with a road in a region, the operations comprising:
obtaining map data of the region, wherein the map data comprises link data of a plurality of links in the region;
determining at least one link pair, corresponding to the road, from among the plurality of links, based on one or more of a link start criterion, a heading criterion, or an uplink criterion;
determining one or more attributes of each link of the obtained at least one link pair; and
generating ramp link data of the road, based on the one or more attributes of each link of the at least one link pair.

18. The computer program product of claim 17, wherein the operations further comprise updating the map data of the region based on the generated ramp link data of the road.

19. The computer program product of claim 17,
wherein the at least one link pair comprises a first link and a second link,
wherein the one or more attributes of each link of the obtained at least one link pair comprise one or more of map speed limit, lane count, or upstream heading of each of the first link and the second link, and
wherein for generating the ramp link data of the road, the operations further comprise determining at least one ramp link for the road from among the first link and the second link, based on a ramp link extraction criterion.

20. The computer program product of claim 19, wherein the ramp link extraction criterion comprises one or more of:
a first condition that a link with least lane count among the first link and second link is the ramp link;
a second condition that a link with least map speed limit among the first link and second link is the ramp link; or
a third condition that a link with highest absolute heading difference with respective main link, among the first link and second link is the ramp link.
